(19) United States
(12) Patent Application Publication
(10) Pub. No.: US 2026/0193502 A1
(43) Pub. Date: Jul. 9, 2026

(54) Laminating Adhesive for Compostable Flexible Packaging

(71) Applicant: Henkel AG & Co. KGaA, Duesseldorf (DE)

(72) Inventors: Sarah Skrzyniarz, Bethlehem, PA (US); Grant Kenion, Easton, PA (US)

(21) Appl. No.: 19/556,297

(22) Filed: Mar. 4, 2026

Related U.S. Application Data
(63) Continuation of application No. PCT/US2024/045331, filed on Sep. 5, 2024.

(30) Foreign Application Priority Data
Sep. 8, 2023 (US) 63581373

(51) Int. Cl. C09J 175/06; B32B 7/12; B32B 27/10; B65D 75/26; C08G 18/42

(52) U.S. Cl. CPC C09J 175/06; B32B 7/12; B32B 27/10; B65D 75/26; C08G 18/4277; B32B 2250/02; B32B 2307/7163; B32B 2439/00

(57) ABSTRACT

Disclosed is a one component, moisture curable, laminating adhesive that provides surprisingly high bond strength and desirable failure mode when bonding a paper film to a polymer film even at the low adhesive coating weights of 1 to 2 pounds per ream, and paper film to polymer film bonded with 1 to 2 pounds per ream of the disclosed adhesive has properties suitable for use as a food or medicine flexible packaging material and the flexible packaging materials will be compostable under ASTM 6400.

### TECHNICAL FIELD

This disclosure relates generally to one component, moisture curable polyurethane laminating adhesives for use in making flexible packaging. More particularly, this disclosure relates generally to solventless, one component, moisture curable polyurethane laminating adhesives that can bond a paper film to a polymer film to provide a compostable flexible packaging.

### BACKGROUND OF THE INVENTION

This section provides background information which is not necessarily prior art to the inventive concepts associated with the present disclosure.

Product packaging has been changing from sealed metal cans and glass bottles to sealed flexible packages such as pouches. As one example tuna fish is now available in both traditional metal cans and flexible pouches. The flexible package when filled with a food or other product and closed or sealed can be readily changed in shape by user manipulation. The flexible package is typically prepared from two layers of flexible packaging material that are overlaid and sealed around most of their periphery to form a cavity inside. Typically, the two layers of flexible packaging material are heat sealed by applying heat and pressure to fuse the polymer layers together around a thin portion of most of the package periphery. Food or other product is placed in the cavity through an opening and the opening is closed by heat sealing the opening layers together. The sealed package and enclosed product can be heated for preservation purposes. In some demanding applications the sealed package and enclosed product can be retorted, that is heated to temperatures of 100° C. or more.

Flexible packaging material is prepared by laminating two or more layers of film. Each film is chosen for specific properties. For example, a flexible packaging material can be a lamination of a paper film to a plastic film. In some embodiments the plastic film is in contact with the food product and the paper film is an exterior surface.

In another embodiment the flexible packaging material can be a lamination of three layers. The inner layer will contact the packaged product. Polypropylene has desirable product contact properties as well as heat sealability and can be used as an inner layer. An optional middle layer can be used to provide a barrier to moisture, oxygen and/or light. Metal films or foils have desirable barrier properties and metal films such as aluminum foil can be used as a middle layer. The outer layer will provide protection for the package and also provides a surface for printing information such as contents, packaging date, warnings, etc. Polyester films are tough, can receive printing ink and can be used as an outer layer. Flexible packaging material can range in thickness from about 13 to about 75 micrometers (0.0005 inches to 0.003 inches).

Each layer of the flexible packaging material is bonded to the adjacent layer by an adhesive. Adhesive can be applied to the layer from a solution in a suitable solvent using gravure or smooth roll coating cylinders or from a solvent-free state using special application machinery and that layer is laminated to the adjacent layer. The laminated packaging material is dried if necessary and accumulated in rolls.

Although there are many possible types of adhesives, polyurethane based adhesives are preferred for use in flexible packaging materials because of their many desirable properties including good adhesion to the materials in each layer, high peel strength, resistance to heat such as from heat sealing or retorting, and resistance to food products. Typically, a two-component polyurethane adhesive is used. The first component is an isocyanate moiety containing (isocyanate functional) polyurethane prepolymer obtained by the reaction of excess diisocyanate with a polyether and/or polyester containing two or more active hydrogen groups per molecule. The second component is usually a polyol. The two components are combined just before use to initiate a cure reaction between the components and applied to the film surfaces to be laminated.

In some embodiments solvent is used as a diluent for some polyurethane laminating adhesives as the viscosity of those mixed adhesives is too high to apply them reliably in liquid form in a roll to roll laminating process. Solvent- or water-based laminating adhesives are limited to an application speed at which the solvent or water can be effectively removed in an oven. Typical line speeds for solvent-based and water-based laminating adhesives are 300 to 600 feet per minute due to the drying restrictions. In other embodiments the laminating adhesives are solventless (adhesives that can be applied at 100% solids and that do not contain either organic solvents or water). Solventless laminating adhesives have a distinct advantage in that they can be applied and run at very high line speeds as there is no solvent or water that must be removed from the adhesive in a drying step. Typical line speeds for solventless adhesives are 900 to even 2000 feet per minute, a line speed not possible with solvent-based and water-based laminating adhesives. Solventless laminating adhesives thus have a distinct advantage over solvent-based or water-borne adhesives. However, at such high line speeds some solventless adhesives will form strings between rollers and in more severe cases the strings can break up into fine particles creating a mist in the atmosphere. Either situation is undesirable for a laminating adhesive.

The cured adhesive must provide suitable peel strength to prevent delamination and contain the food products, both at room temperature and the elevated temperatures encountered during food packaging, processing and serving. The cured adhesive properties must also be unaffected by contact with food products.

There are numerous regulations governing use of flexible packaging material in food packaging applications. Naturally, regulations require that the food packaging be safe when in contact with food. Migration of adhesive constituents, such as unreacted isocyanate monomers into the food product is a concern. Excess isocyanates in a laminating adhesive can react with moisture in packaged products to form primary aromatic amines. The U.S. FDA requires that the concentration of primary aromatic amines in a flexible packaging material used for food contact be below the detection limit (2 parts per billion (ppb) when tested by the migration test, also referred to as the BfR test method). One solution is to keep the flexible packaging material in storage until the adhesive components are fully reacted. After the adhesive components are fully reacted the flexible packaging material is formed into pouches. Unfortunately, in case of laminating adhesives using lower molecular weight prepolymers and polyols this could take a long time, up to a couple of weeks, and involve storage of large amounts of expensive flexible laminating material before it can be used.

In response to the growing challenges of plastic waste to the environment, there is a need to increase recycling and reuse. Composting is nature's way of recycling, where organic materials are broken down by microbes in the soil and the nutrients they contain will be part of the soil like humic substance, called compost. Compostable products by definition are biodegradable. However, compostable products must also break down, or become part of usable, soil-enhancing compost in a safe and timely manner in an appropriate composting facility or home compost pile. To ensure quality of the compost and increase the amount of compostable waste, there is a need to have more food packaging materials be compatible with various composting requirements.

Many have attempted to use biodegradable polymer to create a compostable or biodegradable pressure sensitive adhesive (PSA). Such efforts use polylactic acid (PLA) and sulfonated copolyester to create hotmelt adhesive for beverage cups (US 20200079981). The limitation of this approach is that PLA has poor thermal stability and high moisture sensitivity. It is not suited for many food packaging applications exposed to varying temperature and humidity conditions. Others have used bio-based materials such as epoxidized soybean oil (EP3089868) to make compostable water-based adhesive, however the performance is undesirably limited.

Biodegradable polyurethane (PUR) has been used to develop compostable or biodegradable PSA, such as aliphatic polyester polyol polyurethane used as solvent borne pressure sensitive adhesive (PSA) (U.S. Pat. No. 6,307,003), or PUR reactive hotmelt adhesive based on polyester polyol polyurethane (EP3155034). These approaches offer broad performance but with limited application due to volatile organic compound (VOC) issues and specific application requirements.

It would be desirable to provide a laminating adhesive that makes flexible packaging more compostable.

### SUMMARY OF THE DISCLOSURE

This section provides a general summary of the disclosure and is not a comprehensive disclosure of its full scope or all features, aspects or objectives.

In one embodiment the disclosure includes a one component laminating adhesive. The compostable, one component laminating adhesive comprises a polyisocyanate, a high functionality polyol and a linear diol.

In one embodiment the disclosure includes a one component laminating adhesive. The compostable, one component laminating adhesive comprises an aromatic polyisocyanate, a high functionality polyol and a linear, polyester diol.

In one embodiment the disclosure includes a compostable lamination for a flexible packaging; comprising: a paper film; a polymer film and a one component laminating adhesive. The one component laminating adhesive comprises an aromatic polyisocyanate, a high functionality polyol and a linear, polyester diol.

In one embodiment the disclosure includes a compostable lamination for flexible packaging; comprising: a paper film; a polymer film and a one component laminating adhesive. The one component laminating adhesive comprises an aromatic polyisocyanate, a high functionality polyol and a linear, polyester diol. The lamination is compostable under ASTM D6400.

In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

These and other features and advantages of this disclosure will become more apparent to those skilled in the art from the detailed description of a preferred embodiment.

### DETAILED DESCRIPTION OF THE INVENTION

The singular forms “a”, “an” and “the” include plural referents unless the context clearly dictates otherwise.

Unless otherwise defined “%” refers to weight percent of the composition.

About or “approximately” as used herein in connection with a numerical value refer to the numerical value±10%, preferably ±5% and more preferably ±1% or less.

The term “essentially free” is intended to mean herein that the applicable group, compound, mixture or component constitutes less than 10 wt. %; typically less than 1 wt. %, preferably less than 0.5 wt. %, more preferably less than 0.1 wt. %, and ideally no more than a trace amount based on the weight of the defined composition.

Unless otherwise defined “at least one” means 1 or more, i.e., 1, 2, 3, 4, 5, 6, 7, 8, 9, or more. With reference to an ingredient, the indication refers to the type of ingredient and not to the absolute number of molecules. “At least one polymer” thus means, for example, at least one type of polymer, i.e., that one type of polymer or a mixture of several different polymers may be used.

Unless otherwise defined “liquid” means liquid or flowable under standard room conditions. Typically, liquid materials will have a viscosity of 50,000 cP or less, more typically 20,000 cP or less or preferably 10,000 or less, all at room temperature. As used herein, room temperature is 23° C. plus or minus about 2° C.

The term “paper” encompasses thin films or substrates made predominately or solely from discontinuous cellulose fibers that are typically wet laid into a nonwoven web.

Adhesive weights are provided in pounds per ream. This is the pounds of adhesive applied to a one ream (3,000 square feet or 278.7 square meters) bonding surface of one substrate being bonded.

The terms “comprising” and “comprises” as used herein are synonymous with “including”, “includes”, “containing” or “contains”, and are inclusive or open-ended and do not exclude additional, non-recited members, elements or method steps.

When amounts, concentrations, dimensions and other parameters are expressed in the form of a range, a preferable range, an upper limit value, a lower limit value or preferable upper and lower limit values, it should be understood that any ranges obtainable by combining any upper limit or preferable value with any lower limit or preferable value or any value intermediate the upper and lower limit values are also specifically disclosed, irrespective of whether the obtained ranges are clearly mentioned in the context.

Preferred and preferably are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

Unless specifically noted, throughout the present specification and claims the term molecular weight when referring to a polymer refers to the polymer's number average molecular weight (Mn). The number average molecular weight Mn can be calculated based on end group analysis (OH numbers according to DIN EN ISO 4629, free NCO content according to EN ISO 11909) or can be determined by gel permeation chromatography according to DIN 55672 with THF as the eluent. If not stated otherwise, all given molecular weights are those determined by gel permeation chromatography.

There are numerous definitions and standards for different aspects of biodegradation and compostability. Some standards include Biodegradible Products Institute (BPI), BPI Certification Scheme, Compostable products, resins, and intermediates according to ASTM D6400 and ASTM D6868; European Standard EN 14046, Evaluation of the ultimate aerobic biodegradability and disintegration of packaging materials under controlled composting conditions, Method by analysis of released carbon dioxide; ASTM D5338, Standard Test Method for Determining Aerobic Biodegradation of Plastic Materials Under Controlled Composting Conditions, Incorporating Thermophilic Temperature; ASTM D6400-12, Standard Specification for Labeling of Plastics Designed to be Aerobically Composted in Municipal or Industrial Facilities; Standards Australia AS 5810:2010, Biodegradable plastic—Biodegradable plastics suitable for home composting; and Organization for Economic Co-operation and Development (OECD) 301B and 301C, Modified MITI test—Ready degradability test) Chemical substance—Aerobic biodegradability test by activated sludge JIS K 6950.

Most relevant for this document is ASTM D6400, which defines the characteristics a material must have in order to be claimed as “compostable” and, therefore, be recycled through composting of organic solid waste in an industrial setting. Per section 6.3.2 of ASTM 6400, for materials consisting or more than one polymer to be considered compostable 90% of the organic carbon in the laminated structure needs to be converted to CO2 by the end of the test period when compared to a positive control. This allows 10% of that structure to remain in an original or partially composted state.

Typically, solvent free laminating adhesives are coated at 3 to 5 pounds of adhesive per ream of substrate to provide the necessary bond strength for a laminated structure comprising paper to polymer films. Below this coating weight typical solventless adhesives do not provide sufficient strength to bond the structure and the laminate materials can undesirably separate during use. Laminating adhesives are not compostable, therefore the 3 to 5 pounds per ream of laminating adhesive in a paper/polymer film flexible packaging material contributes significantly to the 10% non-compostable matter allowed under ASTM 6400.

It has unexpectedly been found that the disclosed laminating adhesive can be used at significantly reduced coating rates while maintaining acceptable strength of the bonded flexible packaging. The disclosed adhesive provides acceptable bond strength at very low coating weights. For example, the disclosed laminating adhesive provides acceptable fiber tear bond strength at a coating weight of 1.5 lbs./ream and down to 1.0 lbs./ream with some substrates. At 1.5 lbs./ream the adhesive is only 3% of the laminated structure, well under the allowable 10%. This contributes to the compostability of packaging made using the disclosed laminating adhesive. In addition, the laminating adhesive compositions are advantageous in not having volatile organic compounds (VOC).

The disclosed laminating adhesive compositions comprise isocyanate (NCO) functional polyurethane prepolymer reaction products formed from reaction of a mixture of one or more polyols and one or more polyisocyanates. There is a molar excess of equivalents of isocyanate to equivalents of OH in the mixture so that the prepolymer reaction products are isocyanate (NCO) functional. The adhesive compositions can optionally comprise a catalyst to control the cure speed of these adhesive compositions and can optionally comprise other additives to control rheology and other processing properties. The disclosed laminating adhesive compositions cure in the presence of moisture either from the atmosphere or present on a substrate or as added by an operator during use. The cured reaction products form a thermoset, polyurethane crosslinked network with CO2 given off as a byproduct of the curing process. The thermoset reaction products form lamination bonds that have good heat resistance, good chemical resistance, good adhesion, are free from solvents and can usually be applied at about 80° C.

The disclosed polyurethane adhesive composition can comprise a single component composition. Two-component polyurethane adhesive compositions, wherein the components are stored separately and mixing of the two components starts a cure reaction, are formulated differently from one component polyurethane adhesives. Two component polyurethane adhesives require special handling and equipment; provide chemically different products; and are not interchangeable with one component polyurethane adhesives for every application.

In one embodiment, the isocyanate functional prepolymer is the reaction product of a mixture comprising a polyisocyanate component, a high functionality polyol component and a polyol component.

The polyisocyanate component can be selected from those compounds having two or more reactive isocyanate (NCO) moieties. Organic polyisocyanates that can be used include alkylene diisocyanates, cycloalkylene diisocyanates, aromatic diisocyanates and aliphatic-aromatic diisocyanates. Examples of isocyanates for use in the present disclosure include, by way of example and not limitation: methylenebisphenyldiisocyanate (MDI), isophorone diisocyanate (IPDI), hydrogenated methylenebisphenyldiisocyanate (HMDI), toluene diisocyanate (TDI), ethylene diisocyanate, ethylidene diisocyanate, propylene diisocyanate, butylene diisocyanate, trimethylene diisocyanate, hexamethylene diisocyanate, cyclopentylene-1,3-diisocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like.

Organic polyisocyanates having a functionality of at least three can also be used. These are the trimerization and oligomerization products of the polyisocyanates already mentioned above, such as are obtainable, with the formation of isocyanurate rings, by appropriate reaction of polyisocyanates, preferably of diisocyanates. Where oligomerization products are used, those particularly suitable have a degree of oligomerization of on average from about 3 to about 5. Isocyanates suitable for the preparation of trimers are the diisocyanates already mentioned above, particular preference being given to the trimerization products of the isocyanates HDI, MDI or IPDI. Likewise suitable for use are the polymeric isocyanates, such as are obtained, for example, as a residue in the distillation bottoms from the distillation of diisocyanates. Particularly suitable in this context is the polymeric MDI as is obtainable as a distillation residue from the distillation of MDI.

Organic polyisocyanates that can be used can include one or more isocyanate-functionalized polyurethane prepolymers. A polyurethane prepolymer is a compound such as results, for example, from the reaction of a polyol component (or other active hydrogen-functionalized compound) with an excess of at least one polyisocyanate having a functionality of at least two. The term polyurethane prepolymer embraces not only compounds having a relatively low molecular weight, such as are formed, for example, from the reaction of a polyol with an excess of polyisocyanate, but also oligomeric or polymeric compounds. Likewise embraced by the term polyurethane prepolymers are compounds formed, for example, from the reaction of a trivalent or tetravalent polyol with a molar excess of polyisocyanate, relative to the polyol. While such compounds are commercially available, methods for synthesizing such compounds are well known in the art. Preferred isocyanate-containing compounds are isomers of methylenebisphenyldiisocyanate (MDI), isophorone diisocyanate (IPDI), hydrogenated MDI (HMDI) and toluene diisocyanate (TDI). The polyisocyanate component can comprise a single polyisocyanate or a combination of different polyisocyanates. In one preferred embodiment the polyisocyanate component is an aromatic polyisocyanate, more preferably methylenebisphenyldiisocyanate (MDI). Diphenylmethane diisocyanate (MDI) is available in three isomers, 4,4′-diphenylmethane diisocyanate (4,4′-MDI), 2,4-diphenylmethane diisocyanate (2,4′-MDI), and 2,2′diphenylmethane diisocyanate (2,2′-MDI). Mixtures of two or more of these isomers can be used for some or all of the polyisocyanate component. Alternatively, one or more of these isomers can be excluded. Modified versions of diphenylmethane diisocyanate may be useful for some or all of the polyisocyanate. Examples of useful modified MDIs include e.g., carbodiimide-modified diphenylmethane diisocyanate (carbodiimide-modified MDI), allophanate-modified diphenylmethane diisocyanate (allophanate-modified MDI), biuret-modified diphenylmethane diisocyanate (biuret-modified MDI), polymeric MDI and combinations thereof.

The high functionality polyol component comprises a polyol, preferably a polyester polyol, having an average of two or more primary hydroxyl groups and preferably also having an average of two or more secondary hydroxyl groups. The presence of both multiple primary and multiple secondary hydroxyl groups on the same polyol molecule is beneficial as it allows reaction with the polyisocyanate component at different rates. High functionality polyols are described in U.S. Patent Publication No. 2006/0105188 to Simons, the contents of which are incorporated by reference. The high functionality polyol is obtained by a two step process comprising reacting a first polyol containing predominately secondary hydroxyl groups with a stoichiometric excess of a reactant selected from the group consisting of polybasic acids, polybasic acid anhydrides, polybasic acid esters, and polyisocyanates to form an intermediate containing at least about two terminal functional groups per molecule selected from the group consisting of isocyanate, carboxylic acid and carboxylic acid ester. The intermediate is reacted with a stoichiometric excess of a second polyol containing predominately primary hydroxyl groups to form the high functionality polyol. Reaction of these components in a single step will not provide an acceptable high functionality polyol for use in a laminating adhesive.

The polyol component is different than the high functionality polyol product. The polyol component influences compostability, uncured adhesive composition properties and cured reaction product properties. Therefore, every polyol cannot be used in the compostable laminating adhesive. In this regard polyester polyols are preferred and polyether polyols should generally be avoided. In one embodiment the polyol component is an aliphatic polyester polyol. Preferably, the polyol component is a linear, aliphatic polyester polyol. It has been found that branched polyols cause the uncured laminating adhesive to have an undesirably high viscosity making it difficult or impossible to use. One useful type of linear polyester polyols are the polycaprolactone polyols. Polycaprolactone can be prepared by a ring-opening polymerization (ROP) process under mild conditions using an “initiator” diol or triol and caprolactone monomer. This provides polycaprolactone polyols have 2, 3 or 4 hydroxyl functionality in the molecule and molecular weights of 200 to 5000 g/mol. Polycaprolactone polyols are thermoplastic and typically have a linear structure. Polycaprolactone polyols are commercially available from a number of suppliers, including the CAPA polycaprolactone polyols available from Ingevity.

The mixture can optionally comprise one or more auxiliary polyols different than the high functionality polyol component and the polyol component. Some auxiliary polyols are, for example, polyester polyols, polybutadiene polyols, polycarbonate polyols, polyacetal polyols, polyamide polyols, polyesteramide polyols, polyalkylene polyether polyols, polythioether polyols and mixtures thereof.

The isocyanate functional prepolymer can be present in the laminating adhesive composition in any suitable amount. It is useful when the isocyanate functional prepolymer is present in the laminating adhesive composition in an amount from about 60 wt. % to about 100 wt. %.

The composition can optionally include a catalyst. The catalyst can be any moisture curing catalyst for polyurethanes, for example 2,2′-dimorpholinodiethylether, triethylenediamine, dibutyltin dilaurate and stannous octoate. While metal based catalysts can work, they are preferably not used. If present, organic catalysts are preferred such as the tertiary amine catalyst 2,2′-dimorpholinodiethylether (DMDEE).

The composition can include organic solvents. Preferably, the composition is free of organic solvents. Since the composition is isocyanate functional water and moisture must be excluded during reaction of the isocyanate functional prepolymer and storage to prevent unwanted curing.

The composition can optionally include one or more additives. Common adhesive additives include, for example, adhesion promoters, colorants, UV pigments, fillers, oils, plasticizer, rheology modifiers and combinations thereof. Alternatively, the compositions can be essentially free of any or all of these additives.

The adhesive composition according to the present disclosure can include solvents. Preferably, the adhesive composition according to the present disclosure can be essentially free from any solvents or water in any stage of the formulation.

In one embodiment the liquid moisture curable polyurethane adhesive compositions a reaction product of a mixture comprising:

| | range (wt. %) |
|---|---|
| polyisocyanate component | 40-44 |
| high functionality polyol component | 27-31 |
| polyol component | 27-31 |
| additives | 0-40 |
| total | 100 |

In one embodiment the liquid moisture curable polyurethane adhesive compositions have the following properties:

| | range | narrower range |
|---|---|---|
| | (wt. %) | (wt. %) |
| application temperature C. | 70-90 | 75-85 |
| viscosity cps @ 80 C. | 3000-1000 | 2800-1200 |

Use of the disclosed lamination adhesive below the application temperature may result in misting of the adhesive from the application equipment and stringing (formation of adhesive strings or threads) on the application equipment.

No particular method is required for preparation of the laminating adhesive composition and standard practices can be used. In one embodiment the laminating adhesive composition can be prepared by adding the polyisocyanate components to a reaction vessel. The reaction vessel is heated and placed under vacuum or inert gas atmosphere to remove traces of moisture. Catalyst can optionally be added before or during heating. Once the reaction vessel is generally moisture free the polyol components are added with mixing and allowed to react with the polyisocyanate. If used, additives can be added before the polyisocyanate if they will not interfere with the polyisocyanate-polyol reaction or can be added after the reaction is complete. The final laminating adhesive composition is transferred to a moisture proof container and sealed to exclude moisture.

The laminating adhesive is typically a soft solid at room temperature. As its temperature is raised it gets softer, turning into a liquid in the range of 70-90° C. At 80° C. the laminating adhesive will typically be liquid with a viscosity of about 1600 cps.

The laminating adhesive is heated to about 80° C. in a reservoir of a conventional laminating machine (Nordmeccanica Labo combi 400). The liquid laminating adhesive is picked up by a roller rotating in the reservoir and applied to the surface of a first paper film or plastic film or metal foil. The laminating adhesive is applied in as light a coating as will provide the desired bond strength for the intended films. A second paper film or plastic film or metal foil is guided over the coated surface and the two layers are laminated by passing through the nip rolls. The bonded laminate is accumulated in large rolls. Once the laminating adhesive is cured the composite laminating material can be formed in flexible packaging such as used to contain food products or medicines.

Once applied, the laminating adhesive will cool back to a solid form and provide sufficient green strength to allow handling of the composite laminating material. The applied laminating adhesive, in both the as applied liquid form and solid form will react with moisture on the substrates and in the air to crosslink and cure to a permanent thermoset form. The laminating adhesive will fully cure in 24 hours to 2 weeks, typically 1 week, depending on moisture available on the substrates and in the environment.

The laminating adhesive can be applied to a film at a rate of 1 to 3 pounds/ream; more typically 1 to 2 pounds per ream and as low as 1 to 1.5 pounds/ream. Even at these low application rates the cured laminating adhesive will surprisingly provide sufficient bond strength to tear fibers out of a paper film after only 3 days to 1 week of curing.

When applied at the very low rates of 1 to 3 pounds/ream on a paper to polyethylene terephthalate film laminate, the cured laminating adhesive will provide bond strengths of at least 100 grams/square inch after 3 days of cure time.

The disclosed one component, moisture curable polyurethane laminating adhesive compositions are particularly suited for use in bonding long sheets of paper film to a paper film or plastic film or metal foil to form a large roll of composite laminating material. Once the laminating adhesive is cured the composite laminating material can be formed in flexible packaging such as used to contain food products or medicines. The paper materials are substantially compostable and the cured laminating adhesive can be used at very low application rates so the overall composite laminating material remains at least 90% compostable.

The laminating material prepared in accordance with the present disclosure may be used for packaging purposes in the same manner as conventional or known flexible packaging films. The laminating materials are particularly suitable for forming into flexible pouch-shaped container vessels capable of being filed with a material such as a foodstuff or medicament and sealed. For example, two rectangular or square sheets of the laminating material may be piled in the desired configuration or arrangement; preferably, the two polymer layers of the two sheets are adjacent each other and can be heat-sealed to each other. Three peripheral portions of the piled assembly are then heat-sealed to form the pouch with one open side to allow for filing. Alternatively a piece of laminating material can be bent so the polymer surfaces are adjacent and two of the three open edges can be heat sealed. Heat-sealing can easily be accomplished by means of a heating bar, heating knife, heating wire, impulse sealer, ultrasonic sealer, or induction heating sealer. The material is thereafter packed in the so-formed pouch through the open edge, which is subsequently heat sealed.

### Bond Strength Testing

A laminate comprising a 4 to 5 inch wide paper substrate bonded to a second 4 to 5 inch wide substrate of the desired test material by the desired amount and type of laminating adhesive is prepared. The adhesive is applied to give a I inch bond along one edge of the substrates. Samples of the laminate are allowed to cure for 3 days, 1 week and 2 weeks.

1 inch wide by 4-5 inch long strips of cured laminate are made with the bonding area being 1 inch by 1 inch. The unbonded edges of each test strip are place in a tensile tester (Instron) so to provide a 180 degree pull. The sample is tested at 12 inches/minute and the average force for 3 tests is recorded. Results are in gram-force.

### Elevated Temperature Bond Strength Testing

A sample is prepared as described in bond testing. The cured sample is placed in a tensile test machine. Once secured to the tensile test machine, the sample is placed in a 70° C. environment for one minute. After one minute tensile testing is started as described in bond testing and the average force for 3 tests is recorded.

### Hand Pull Bond Testing

A sample is prepared as described in bond testing. The cured sample is held with one unbonded tail in each hand. The unbonded tails are pulled at 180 degrees until the films are separated. The separated films are visually evaluated for failure mode and fiber tear.

### Fiber Tear Evaluation

After a cured sample is tested for bond strength the polymer film is visually examined for paper fibers pulled from the paper film and remaining bonded to the polymer film. Scoring is based on area of bonded fibers/1 inch square bond area. Fiber tear is visual examination looking for paper fibers on the opposite films. A minimum fiber tear after 24 hours cure time of 10% can be acceptable but is more preferably 50% or more. With longer cure times the minimum fiber tear will increase to 50% or more.

### Viscosity Testing

Viscosity was tested using a Brookfield viscosimeter with a LVT #31 spindle at 100 rpm and a desired temperature. The adhesive sample, spindle, and thermosel were preheated to the desired temperature before testing began. The sample was run for about ten minutes before a reading was taken.

### Lamination Adhesive Preparation

Lamination adhesive samples were prepared as follows. The polyisocyanate component was added to a vessel which was sealed. The polyisocyanate component was heated in an inert atmosphere to remove moisture. Dried high functionality polyol component and linear polyester diol component were added to the dried polyisocyanate component with stirring. The polyisocyanate component was in an equivalent excess compared to the total polyol components. The polyisocyanate component was allowed to react with high functionality polyol component and the linear polyester diol component. After the high functionality polyol component and the linear polyester diol component had been reacted, the isocyanate functional laminating adhesive composition was transferred to a moisture proof container and sealed to exclude moisture.

The following substrates were used in the lamination samples. Each substrate was in a roll approximately 6 inches wide.

| | |
|---|---|
| PE | polyethylene, 200 gauge (2.0 mil, 0.051 mm, 0.002 |
| | inches) thickness |
| PLA | polylactic acid film |
| metPET | metallized one side polyester terephthalate, 48 gauge |
| | (0.48 mils, 0.12 mm, 0.00048 inches) thickness |
| PET | polyester terephthalate, 48 gauge (0.48 mils, 0.12 mm, |
| | 0.00048 inches) thickness |
| PET (ink) | polyester terephthalate - printed one side, 48 gauge |
| | (0.48 mils, 0.12 mm, 0.00048 inches) thickness |
| OPP | oriented polypropylene |
| PET/ALU | polyester terephthalate (48 gauge, 0.48 mils, 0.12 mm, |
| PRELAM | 0.00048 inches) thickness) adhesively bonded to |
| | aluminum film |
| C1S | paper coated one side |
| C1S Flipped | paper coated one side (inventive adhesive applied on |
| | non-calendared side) |
| Kraft paper | |
| cello film | |
| 70 lb. Bright | printer paper |
| White | |
| DL Media | packaging paper with one side printed (adhesive |
| Paper | applied to non-printed side) |
| Glassine paper | |
| Technoplex | base material for bandage. |
| Bandage Paper | |

### EXAMPLES

### Example 1

A laminating adhesive was prepared using the following components.

| Component | Wt. % |
|---|---|
| Polyisocyanate component¹ | 42.0 |
| High functionality polyol component² | 29.0 |
| Linear, polyester diol component³ | 29.0 |

¹MDI available from Wanhua
²a polyester polyol having an average of about two primary hydroxyl groups and about two secondary hydroxyl groups prepared according to U.S. Patent Publication No. 2006/0105188.
³CAPA 2102AJ available from Ingenity.

Example 1 was a solid at room temperature and had a viscosity of 1632 cps at 80° C. and was suitable for application as a laminating adhesive for bonding films and foils.

### Example 2

A laminating adhesive was prepared using the following components.

| Component | Wt. % |
|---|---|
| Polyisocyanate component¹ | 36.2 |
| High functionality polyol component² | 40.1 |
| Linear, polyester diol component³ | 23.7 |

¹MDI available from Wanhua
²a polyester polyol having an average of about two primary hydroxyl groups and about two secondary hydroxyl groups prepared according to U.S. Patent Publication No. 2006/0105188.
³CAPA 2102AJ available from Ingevity.

Example 2 was a solid at room temperature and had a viscosity of 10,000 cps at 80° C.

Example 2 had a molten viscosity too high for use as a lamination adhesive.

### Example 3

A laminating adhesive was prepared using the composition of Example 1. The adhesive was laminated to various substrates, cured for 24 hours at room temperature and humidity (45% RH) and the cured laminating material was tested for failure mode by hand pulling the unbonded sides of a 1 inch test lamination in a 180 degree orientation. The adhesive was applied to the calendared side of the paper via a roller coater at 80° C., the second substrate was applied and the lamination nip temperature was 80° C.

| | Adhesive | | | |
|---|---|---|---|---|
| Sam- | Coat | Primary | Secondary | |
| ple | Weight¹ | Substrate | Substrate | Hand Pull Failure Mode |
| 3.1 | 2.75 | PLA | C1S Paper | >50% Fiber tear |
| 3.2 | 2.75 | metPET | C1S Paper | >50% Fiber tear |
| 3.3 | 2.75 | PET (ink) | C1S Paper | >50% Fiber tear + |
| | | | | slight ST²- PET |
| 3.4 | 2.75 | OPP | C1S Paper | >50% Fiber tear |
| 3.5 | 2.75 | PET/ALU | C1S Paper | >50% Fiber tear |
| | | (PRELAM) | | |
| 3.6 | 2.75 | PET | C1S Paper | 50% Fiber tear, 50% ST- |
| | | | | PET |
| 3.7 | 2.75 | PET | Kraft | Fiber tear + ST- paper |
| | | | Paper | |
| 3.8 | 2.1 | PLA | C1S Paper | >50% Fiber tear + |
| | | | | slight ST- paper |
| 3.9 | 2.1 | metPET | C1S Paper | >50% Fiber tear |
| 3.10 | 2.1 | PET (ink) | C1S Paper | >50% Fiber tear + |
| | | | | partial ST- PET |
| 3.11 | 2.1 | OPP | C1S Paper | >50% Fiber tear |
| 3.12 | 2.1 | PET/ALU | C1S Paper | >50% Fiber tear |
| | | (PRELAM) | | |
| 3.13 | 2.1 | PET | C1S Paper | >50% Fiber tear |
| 3.14 | 2.1 | PET | Kraft | >50% Fiber tear |
| | | | Paper | |
| 3.15 | 2.75 | PET | C1S Paper | >50% Fiber tear + ST- |
| | | | (flipped) | PET |

¹adhesive weight in pounds per ream
²ST is tearing of the identified substrate material

### Example 4

A laminating adhesive was prepared using the composition of Example 1. The adhesive was laminated to various substrates and the laminated material was cured for 3 days or 1 week or 2 weeks and tested for room temperature bond strength and failure mode. The adhesive was applied to the calendared side of the paper via a roller coater at 80° C., the second substrate was applied and the lamination nip temperature was 80° C.

| | | | 3 Days | Failure | 1 Week | Failure | 2 Week | Failure |
|---|---|---|---|---|---|---|---|---|
| Sample | Weight¹ | Laminate | bs² (gf) | Mode³ | bs² (gf) | Mode | bs² (gf) | Mode³ |
| 4.1 | 2.75 | PLA/C1S | 235 | FT then | 256 | FT then | 264 | FT then |
| | | Paper | | ST- paper | | ST- paper | | ST-paper |
| 4.2 | 2.75 | metPET/C1S | 216 | FT then | 266 | FT then | 238 | FT then |
| | | Paper | | ST- paper | | SS- paper | | ST-paper |
| 4.3 | 2.75 | PET | 235 | FT then | 238 | FT then | 244 | FT then |
| | | (ink)/C1S | | ST- paper | | ST- paper | | ST-paper |
| | | Paper | | | | | | |
| 4.4 | 2.75 | OPP/C1S | 220 | FT then | 287 | FT then | 268 | FT then |
| | | Paper | | ST- paper | | ST- paper | | ST-paper |
| 4.5 | 2.75 | PET/ALU | 252 | FT then | 213 | FT then | 251 | FT then |
| | | (PRELAM)/ | | ST- paper | | SS- paper | | ST-paper |
| | | C1S Paper | | | | | | |
| 4.6 | 2.75 | PET/C1S | 241 | FT then | 185 | FT then | 265 | FT then |
| | | Paper | | ST- paper | | SS- paper | | ST-paper |
| 4.7 | 2.75 | PET/Kraft | 400 | FT then | 337 | FT then | 431 | FT then |
| | | Paper | | ST- paper | | ST- paper | | ST-paper |
| 4.8 | 2.1 | PLA/C1S | 241 | FT then | 263 | FT then | 217 | FT then |
| | | Paper | | ST- paper | | ST- paper | | ST-paper |
| 4.9 | 2.1 | metPET/C1S | 256 | FT then | 261 | FT then | 243 | FT then |
| | | Paper | | ST- paper | | ST- paper | | ST-paper |
| 4.10 | 2.1 | PET (ink)/ | 199 | FT then | 231 | FT then | 214 | FT then |
| | | C1S Paper | | ST- paper | | ST- paper | | ST-paper |
| 4.11 | 2.1 | OPP/C1S | 237 | FT then | 265 | FT then | 277 | FT then |
| | | Paper | | ST- paper | | ST- paper | | ST-paper |
| 4.12 | 2.1 | PET/ALU | 169 | FT | 140 | FT | 180 | FT |
| | | (PRELAM)/ | | | | | | |
| | | C1S Paper | | | | | | |
| 4.13 | 2.1 | PET/C1S | 232 | FT then | 116 | FT | 225 | FT then |
| | | Paper | | ST- paper | | | | ST-paper |
| 4.14 | 2.1 | PET/Kraft | 361 | FT then | 365 | ST- paper | 168 | ST- paper |
| | | Paper | | ST- paper | | | | |
| 4.15 | 2.75 | PET/C1S | 548 | FT then | 383 | FT then | 464 | FT then |
| | | Paper | | ST- paper | | ST- paper | | ST-paper |
| | | Flipped | | | | | | |

¹adhesive weight in pounds/ream
²average bond strength
³FT is fiber tear of the paper substrate and ST is tearing of the identified substrate material.

The laminating adhesive had adequate strength and failure mode in each combination for use as a flexible packaging material. All fiber tear results were >50% and approaching 100% until the paper film started tearing.

### Example 5

A laminating adhesive was prepared using the composition of Example 1. The adhesive was laminated to various substrates and the laminated material was cured for 3 days or 1 week or 2 weeks and tested for elevated temperature (70° C.) bond strength and failure mode. For most samples the adhesive was applied to the calendared side of the paper via a roller coater at 80° C., the second substrate was applied and the lamination nip temperature was 80° C.

The following substrates were used:

| | | | 3 Days | Failure | 1 Week | Failure | 2 Week | Failure |
|---|---|---|---|---|---|---|---|---|
| Sample | Weight¹ | Laminate | bs² (gf) | Mode | bs² (gf) | Mode | bs² (gf) | Mode |
| 5.1 | 2.75 | PLA/C1S | 261 | FT then | 187 | FT then | 257 | FT then |
| | | Paper | | ST- paper | | ST- paper | | ST- paper |
| 5.2 | 2.75 | metPET/ | 220 | FT then | 241 | FT then | 207 | FT then |
| | | C1S Paper | | ST- paper | | ST- paper | | ST- paper |
| 5.3 | 2.75 | PET | 167 | FT then | 204 | FT then | 202 | FT then |
| | | (ink)/C1S | | ST- paper | | ST- paper | | ST- paper |
| | | Paper | | | | | | |
| 5.4 | 2.75 | OPP/C1S | 202 | FT then | 232 | FT then | 204 | FT then |
| | | Paper | | ST- paper | | ST- paper | | ST- paper |
| 5.5 | 2.75 | PET/ALU | 250 | FT then | 178 | FT then | 141 | FT |
| | | (PRELAM)/ | | ST- paper | | ST- paper | | |
| | | C1S Paper | | | | | | |
| 5.6 | 2.75 | PET/C1S | 225 | FT then | 194 | FT then | 216 | FT then |
| | | Paper | | ST- paper | | SS- paper | | ST- paper |
| 5.7 | 2.75 | PET/Kraft | 365 | FT then | 351 | FT then | 287 | FT |
| | | Paper | | ST- paper | | ST- paper | | |
| 5.8 | 2.1 | PLA/C1S | 241 | FT then | 238 | FT then | 248 | FT then |
| | | Paper | | ST- paper | | ST- paper | | ST- paper |
| 5.9 | 2.1 | metPET/ | 145 | FT | 205 | FT then | 186 | FT then |
| | | C1S Paper | | | | ST- paper | | ST- paper |
| 5.10 | 2.1 | PET | 201 | FT then | 208 | FT then | 184 | FT then |
| | | (ink)/C1S | | ST- paper | | ST- paper | | ST- paper |
| | | Paper | | | | | | |
| 5.11 | 2.1 | OPP/C1S | 219 | FT then | 231 | FT then | 217 | FT then |
| | | Paper | | ST- paper | | ST- paper | | ST- paper |
| 5.12 | 2.1 | PET/ALU | 126 | FT | 123 | FT | 155 | FT |
| | | (PRELAM)/ | | | | | | |
| | | C1S Paper | | | | | | |
| 5.13 | 2.1 | PET/C1S | 219 | FT then | 145 | FT | 194 | FT then |
| | | Paper | | ST- paper | | | | ST- paper |
| 5.14 | 2.1 | PET/Kraft | 345 | FT then | 345 | ST- Paper | 337 | ST- paper |
| | | Paper | | ST- paper | | | | |
| 5.15 | 2.75 | PET/C1S | 519 | FT then | 433 | FT then | 404 | ST- paper |
| | | Paper | | ST- paper | | ST- paper | | |
| | | Flipped | | | | | | |

¹adhesive weight in pounds per ream
²elevated temperature average bond strength

Even at elevated temperature (80° C.), the laminating adhesive had adequate strength and failure mode in each combination for use as a flexible packaging material. Fiber tear results were all greater than 50% and many approached 100% until the paper stock broke.

### Example 6

A laminating adhesive was prepared using the composition of Example 1. The adhesive was laminated to various substrates and the laminated material was cured for 1 day at room temperature and 40% humidity and tested for failure mode by hand pulling the unbonded sides of a 1 inch test lamination in a 180 degree orientation. The adhesive was applied to the calendared side of the paper via a roller coater at 80° C., the second substrate was applied and the lamination nip temperature was 80° C.

| | Adhesive | Primary | Secondary | Hand Pull |
|---|---|---|---|---|
| Sample | Coat Weight¹ | Substrate | Substrate | Failure Mode |
| 6.1 | 2.85 | PET | C1S Paper | Fiber Tear |
| 6.2 | 2.85 | Cello film | C1S Paper | Fiber Tear |
| 6.3 | 2.85 | PLA | C1S Paper | Fiber Tear |
| 6.4 | 2.1 | PET | C1S Paper | Fiber Tear |
| 6.5 | 2.1 | Cello film | C1S Paper | Fiber Tear |
| 6.6 | 2.1 | PLA | C1S Paper | Fiber Tear |

¹adhesive weight in pounds per ream

After only 24 hours of cure time at room temperature and 40% humidity the laminating adhesive surprisingly had adequate fiber tear failure mode in each combination for use as a flexible packaging material.

### Example 7

A laminating adhesive was prepared using the composition of Example 1. The adhesive was laminated to various substrates and the laminated material was cured for 3 days or 1 week or 2 weeks and tested for room temperature bond strength and failure mode. The adhesive was applied to the calendared side of the paper via a roller coater at 80° C., the second substrate was applied and the lamination nip temperature was 80° C.

| | | Primary | 3 Days | Failure | 1 Week | Failure | 2 Week | Failure |
|---|---|---|---|---|---|---|---|---|
| Sample | Weight¹ | Substrate | bs² (gf) | Mode³ | bs² (gf) | Mode³ | bs² (gf) | Mode³ |
| 7.1 | 2.85 | PET | 144.33 | Fiber tear | 152 | Fiber tear | 223 | Fiber tear |
| 7.2 | 2.85 | Cello film | 168.33 | Fiber tear | 163.33 | Fiber tear | 161 | Fiber tear |
| 7.3 | 2.85 | PLA | 150 | Fiber tear | 304 | Fiber tear | 164 | Fiber tear |
| 7.4 | 2.1 | PET | 141.67 | Fiber tear | 141.33 | Fiber tear | 146 | Fiber tear |
| 7.5 | 2.1 | Cello film | 364.33 | Fiber tear | 152.67 | Fiber tear | 160.67 | Fiber tear |
| | | | | w/slight | | | | |
| | | | | SS- paper | | | | |
| 7.6 | 2.1 | PLA | 163.67 | Fiber tear | 166 | Fiber tear | 232.67 | Fiber tear |

¹adhesive weight in pounds/ream
²average bond strength
³FT is fiber tear of the paper substrate and ST is tearing of the identified substrate material.

### Example 8

A laminating adhesive was prepared using the composition of Example 1. The adhesive was laminated to various substrates and the laminated material was cured for 3 days or 1 week or 2 weeks and tested for elevated temperature (70° C.) bond strength and failure mode. The adhesive was applied to the calendared side of the paper via a roller coater at 80° C., the second substrate was applied and the lamination nip temperature was 80° C.

| | | | 3 Days | Failure | 1 Week | Failure | 2 Week | Failure |
|---|---|---|---|---|---|---|---|---|
| Sample | Weight¹ | Laminate | bs² (gf) | Mode³ | bs² (gf) | Mode | bs² (gf) | Mode³ |
| 8.1 | 2.85 | PET | 508 | PET | 245.5 | Fiber tear | 284 | Fiber tear |
| | | | | fracture | | | | w/partial |
| | | | | | | | | SS- paper |
| 8.2 | 2.85 | Cello film | 242.33 | Fiber tear | 159 | Fiber tear | 210.33 | Fiber tear |
| 8.3 | 2.85 | PLA | 332.67 | Film | 253 | Fiber tear | 137.67 | Fiber tear |
| | | | | elongation | | | | |
| 8.4 | 2.1 | PET | 147.67 | Fiber tear | 131.33 | Fiber tear | 138.67 | Fiber tear |
| 8.5 | 2.1 | Cello film | 241.67 | Fiber tear | 242.5 | Fiber tear | 143.67 | Fiber tear |
| | | | | w/ partial | | | | |
| | | | | ST- paper | | | | |
| 8.6 | 2.1 | PLA | 254 | Film | 143.67 | Fiber tear | 131.67 | Fiber tear |
| | | | | elongation | | | | |

¹adhesive weight in pounds/ream
²average bond strength
³FT is fiber tear of the paper substrate and ST is tearing of the identified substrate material.

### Example 9

A laminating adhesive was prepared using the composition of Example 1. The adhesive was laminated to various substrates and the laminated material was cured for 1 day (24 hours) at room temperature and humidity and tested for failure mode by hand pulling the unbonded sides of a 1 inch test lamination in a 180 degree orientation. The adhesive was applied to the secondary substrate (PET) via a roller coater at 80° C., the primary substrate was applied and the lamination nip temperature was 80° C.

| | Adhesive | | | |
|---|---|---|---|---|
| | Coat | Primary | Secondary | Hand Pull |
| Sample | Weight¹ | Substrate | Substrate | Failure Mode |
| 9.1 | 1.8 | C1S paper | PET | Peel, w/30% FT |
| 9.2 | 1.5 | C1S paper | PET | Peel |
| 9.3 | 1 | C1S paper | PET | Peel |
| 9.4 | 2.1 | 70 lb. Bright White | PET | Peel, 10% FT |
| 9.5 | 2.1 | Kraft Paper | PET | Peel, both sides |
| | | | | had adhesive |
| 9.6 | 2.1 | DL Media Paper | PET | Peel |
| 9.7 | 2.1 | Glassine Paper | PET | ST |
| 9.8 | 2.1 | Technoplex | PET | Peel |
| | | Bandage Paper | | |

¹adhesive weight in pounds per ream

After only 24 hours of cure time at room temperature and 40% humidity the laminating adhesive at lighter coating weights had a peel away from the substrate failure mode and would be acceptable but not preferred for use as a flexible packaging material. The laminates would be expected to have increased bond strength and increased fiber tear at 3 days and one week of cure time.

### Example 10

A laminating adhesive was prepared using the composition of Example 1. The adhesive was laminated to various substrates and the laminated material was cured for 3 days or 1 week or 2 weeks and tested for elevated temperature bond strength and failure mode. The primary substrate in each test was PET. The adhesive was applied to the PET primary substrate via a roller coater at 80° C., the secondary substrate was applied and the lamination nip temperature was 80° C.

| | Adhesive | Secondary | 3 Days | Failure | 1 Week | Failure | 2 Weeks | Failure |
|---|---|---|---|---|---|---|---|---|
| Sample | Weight¹ | Substrate | bs² (gf) | Mode³ | bs² (gf) | Mode³ | bs² (gf) | Mode³ |
| 10.1 | 1.8 | 41 lb. C1S | 131 | Fiber tear | 124 | Fiber tear | 125 | Fiber tear |
| | | Paper | | | | | | |
| 10.2 | 1.5 | 41 lb. C1S | 137 | Fiber tear | 136 | Fiber tear | 126 | Fiber tear |
| | | Paper | | | | | | |
| 10.3 | 1 | 41 lb. C1S | 141 | Fiber tear | 133 | Fiber tear | 130 | Fiber tear |
| | | Paper | | | | | | |
| 10.4 | 2.1 | 70 lb. Bright | 380 | 95% Ft, then | 1350 | ST- PET | 167 | Fiber tear |
| | | White | | SS- PET | | | | |
| 10.5 | 2.1 | Kraft paper | 113 | Peel, adh | 114 | Zipper | 193 | SS- PET |
| | | | | on PET | | | | |
| 10.6 | 2.1 | DL Media | 399 | ST- PET | 381 | ST- PET | 363 | ST- PET |
| | | paper | | | | | | |
| | | (unprinted) | | | | | | |
| 10.7 | 2.1 | Glassine | 442 | ST- paper | 435 | ST- paper | 423 | ST- paper |
| | | paper | | | | | | |
| 10.8 | 2.1 | Technoplex | 314 | FT then | 322 | ST- paper | 357 | SS- paper |
| | | Bandage | | ST- paper | | | | |
| | | paper | | | | | | |
| 10.9 | 2.1 | PET/PE | 877 | ST- PET | 981 | ST- PET | 1125 | ST- PET |

¹adhesive weight in pounds/ream
²average bond strength
³FT is fiber tear of the paper substrate and ST is tearing of the identified substrate material.

All of the fiber tear results were at or about 100%. At 3 days cure time even the lightest laminating adhesive coating weight provided surprisingly high strength and desirable failure mode and would be suitable for use as a flexible packaging material.

### Example 11

A laminating adhesive was prepared using the composition of Example 1. The adhesive was laminated to various substrates and the laminated material was cured for 3 days or 1 week or 2 weeks and tested for elevated temperature (70° C.) bond strength and failure mode. The primary substrate in each test was PET. The adhesive was applied to the PET primary substrate via a roller coater at 80° C., the secondary substrate was applied and the lamination nip temperature was 80° C.

| | Adhesive | Secondary | 3 Days | Failure | 1 Week | Failure | 2 Weeks | Failure |
|---|---|---|---|---|---|---|---|---|
| Sample | Weight¹ | Substrate | bs² (gf) | Mode³ | bs² (gf) | Mode³ | bs² (gf) | Mode³ |
| 11.1 | 1.8 | 41 lb. C1S | 123 | Fiber tear | 122 | Fiber tear | 124 | Fiber tear |
| | | Paper | | | | | | |
| 11.2 | 1.5 | 41 lb. C1S | 127 | Fiber tear | 129 | Fiber tear | 122 | Fiber tear |
| | | Paper | | | | | | |
| 11.3 | 1 | 41 lb. C1S | 140 | Fiber tear | 123 | Fiber tear | 125 | Fiber tear |
| | | Paper | | | | | | |
| 11.4 | 2.1 | 70 lb. Bright | 341 | Peel, | 1355 | ST- PET | 448 | ST- PET |
| | | White | | extremely | | | | |
| | | | | thin layer | | | | |
| | | | | of fiber on | | | | |
| | | | | PET | | | | |
| 11.5 | 2.1 | Kraft paper | 31 | Peel, adh | 247 | Peel, then | 206 | SS- PET |
| | | | | on both | | SS- PET | | |
| | | | | sides | | | | |
| 11.6 | 2.1 | DL Media paper | 241 | Peel, adh | 424 | ST- PET | 399 | ST- PET |
| | | (unprinted) | | on both | | | | |
| | | | | sides | | | | |
| 11.7 | 2.1 | Glassine paper | 242 | Peel, adh | 407 | ST- paper | 373 | ST- paper |
| | | | | on PET | | | | |
| | | | | (a little on | | | | |
| | | | | paper) | | | | |
| 11.8 | 2.1 | Technoplex | 121 | Peel, adh | 325 | ST- PET | 344 | ST- PET |
| | | Bandage paper | | on both | | | | |
| | | | | sides | | | | |

¹adhesive weight in pounds/ream
²average bond strength
³FT is fiber tear of the paper substrate and ST is tearing of the identified substrate material.

All of the fiber tear results were at or about 100%. Even at elevated temperature (80° C.), the laminating adhesive at very light coating weights (1 to 1.8 pounds/ream) had surprisingly high strength and desirable failure mode on 41 lb. C1S paper for use as a flexible packaging material. For some other substrate combinations such as sample 11.5 with Kraft paper a longer cure time would be useful.

### Example 12

A laminating adhesive was prepared using the composition of Example 1. The adhesive was applied to the PET primary substrate via a roller coater at 80° C., the PE substrate was applied and the lamination nip temperature was 80° C. The laminated material was cured for 3 days or 1 week or 2 weeks. After curing, two samples were overlaid so the PE surfaces were in contact and the PE surfaces were fused into a heat seal. The heat seals were formed from a single cured laminate strip folded to dispose the PE surfaces adjacent to one another. The heat seals were created using a SencorpWhite model 12-ASL/1 set to 40 psi, 300F and 1 second seal time. The heat seal was tested for room temperature strength and failure mode.

| | | 3 Days | Failure | 1 Week | Failure | 2 Week | Failure |
|---|---|---|---|---|---|---|---|
| Sample | Weight¹ | bs² (gf) | Mode³ | bs² (gf) | Mode³ | bs² (gf) | Mode³ |
| 12.1 | 2.1 | 3717 | ST³ with very | 8573 | ST | 8160 | ST |
| | | | slight PET | | | | |
| | | | delam on edge | | | | |

¹adhesive weight in pounds per ream
²average bond strength
³ST is stock tear or tearing of the identified film.

What is claimed is:

1. A one component, isocyanate functional, moisture curable laminating adhesive comprising the reaction products of a mixture of a polyisocyanate component; a high functionality polyester polyol component and a linear polyester polyol component.

2. The one component, isocyanate functional, moisture curable laminating adhesive of claim 1, wherein the high functionality polyester polyol component has a functionality of about 4 and comprises about 2 primary hydroxyl groups and two secondary hydroxyl groups per molecule.

3. The one component, isocyanate functional, moisture curable laminating adhesive of claim 1, wherein the linear polyester polyol component comprises a polycaprolactone polyol.

4. The one component, isocyanate functional, moisture curable laminating adhesive of claim 1, wherein cured reaction products of the adhesive provide >50% fiber tear and >100 grams strength when coated between a C1 S paper film and a PET film at 1.5 pounds per ream.

5. The one component, isocyanate functional, moisture curable laminating adhesive of claim 1, further comprising an additional polyol different from the high functionality polyester polyol component and the linear polyester polyol component.

6. The one component, isocyanate functional, moisture curable laminating adhesive of claim 1, wherein the mixture comprises about 40 to 44 wt. % of the polyisocyanate component; about 27 to 31 wt. % of the high functionality polyester polyol component and about 27 to 31 wt. % of the linear polyester polyol component.

7. A flexible packaging lamination comprising a paper substrate bonded to a second substrate by cured reaction products of a one component, isocyanate functional, moisture curable laminating adhesive comprising the reaction products of a mixture of a polyisocyanate component; a high functionality polyester polyol component and a linear polyester polyol component.

8. The flexible packaging lamination of claim 7, comprising about 1 to 4 pounds of adhesive per ream of substrate.

9. The flexible packaging lamination of claim 7, having a bond strength of more than 100 grams-force and a fiber tear of greater than 50%.

10. The flexible packaging lamination of claim 7, wherein the flexible packaging material is compostable when tested under ASTM 6400.

11. The flexible packaging lamination of claim 7, wherein the first and second substrates are each independently selected from a paper film, a polymer film, a metalized polymer film or a metal foil.

12. The flexible packaging lamination of claim 7, comprising about 1 to 1.5 pounds of adhesive per ream of substrate.

13. A flexible package, comprising:
a first portion of a flexible laminating material having a periphery and comprising a polymer film bonded to a paper film by cured reaction products of a one component laminating adhesive, the one component laminating adhesive including an aromatic polyisocyanate, a high functionality polyol and a linear, polyester diol; and
a second portion of a flexible laminating material having a periphery and comprising a polymer film bonded to a paper film by cured reaction products of a one component laminating adhesive, the one component laminating adhesive including an aromatic polyisocyanate, a high functionality polyol and a linear, polyester diol;
the first portion being disposed adjacent the second portion and the first portion being sealed to the second portion around at least some of the periphery to form a pouch having an interior cavity for receiving a material;
wherein the flexible package is compostable when tested under ASTM 6400.

14. The flexible package of claim 13 wherein the polymer film of the first portion of flexible laminating material is disposed adjacent the polymer film of the second portion of flexible laminating material and the polymer film of the first portion of flexible laminating material is heat sealed to the polymer film of the second portion of flexible laminating material around at least some of the periphery to form the pouch having the interior cavity for receiving the material.

15. The flexible package of claim 13 wherein the first portion of flexible laminating material and the second portion of laminating material are opposing ends of one piece of flexible laminating material that is folded over itself.
